(19) United States
(12) Patent Application Publication
(10) Pub. No.: US 2018/0246955 A1
(43) Pub. Date: Aug. 30, 2018

(54) METHOD AND DEVICE FOR SEARCHING LEGAL PROVISION

(71) Applicant: Beijing Gridsum Technology Co., Ltd., Beijing (CN)

(72) Inventors: Xin He, Beijing (CN); Ning Du, Beijing (CN)

(21) Appl. No.: 15/774,928

(22) PCT Filed: Nov. 25, 2016
(86) PCT No.: PCT/CN2016/107311

§ 371 Date: May 9, 2018

(30) Foreign Application Priority Data
Dec. 1, 2015 (CN) 201510869254.1

(51) Int. Cl. G06F 17/30; G06Q 50/18

(52) U.S. Cl. CPC G06F 17/30684; G06Q 50/18; G06F 17/30699

(57) ABSTRACT

Disclosed are a method and device for searching for the legal provision. The method includes: a search keyword in a search query text is acquired (S101); a legal term which has a meaning similar to and/or the same as the meaning of the search keyword is acquired (S102); the search query text is expanded according to the legal term which has the meaning similar to and/or the same as the meaning of the search keyword to obtain an expanded search query text (S103); searching is performed according to the expanded search query text to obtain a target judgment document set (S104); and a target legal provision of the target judgment document set is acquired (S105). Through the method, the problem in the relevant art of difficulty in acquisition of a relevant legal provision according to an input search term is solved.

### TECHNICAL FIELD

The present disclosure relates to the field of information search, and more particularly to a method and device for searching for a legal provision.

### BACKGROUND

A legal provision refers to a currently effective law, an administrative regulation, a judicial interpretation, a local regulation, a local rule, a departmental rule and other normative documents as well as a untimely amendment and supplement for these laws and regulations. In a broad sense, the law refers to all normative documents in general. A judgment document records a trial process and result of the people's court, is a carrier of a litigious activity result, and is also the only certificate for determining and allocating a substantive right and duty for a party by the people's court. The judgment document not only is a certificate for entitling the party to the right and burdening the duty on the party, but also is an important basis for a superior people's court to supervise a civil trial activity of an inferior people's court. A judgment document which has a complete structure, has full elements and is logically rigorous should include the case description of a dispute case, information about a plaintiff, a defendant and their clients, a legal provision for case judgment of the court, and the like. Nowadays, a legal professional usually needs to search for a law and regulation similar to a currently settled case in a dispute case. When meeting a dispute, an ordinary person desires to find a law and regulation for the meeting dispute to serve as a reference of legislative confirmation. Therefore, by inputting a search query text including case description information, an effective judgment document relevant to the input text is able to be obtained, and accordingly, a legal provision serving as a basis for case judgment of the courts is able to be obtained. However, in a current search process of a law and regulation, a current search engine mainly splits and matches a word for a search text based on case input. For example, a search term based on case input is Drag-racing, which is not enough to search a legal provision. Therefore, it is difficult to find a legal provision relevant to a case description.

Any effective solution has not been provided yet for the problem in the related art of difficulty in acquisition of a relevant legal provision according to an input search term.

### SUMMARY

The main objective of the present disclosure is to provide a method and device for searching for a legal provision, used to solve the problem in the related art of difficulty in acquisition of a relevant legal provision according to an input search term.

According to an embodiment of the present disclosure, a method for searching for a legal provision is provided, including: acquiring a search keyword in a search query text; acquiring a legal term which has a meaning similar to and/or the same as a meaning of the search keyword; expanding the search query text according to the legal term which has the meaning similar to and/or the same as the meaning of the search keyword, as to obtain an expanded search query text; searching according to the expanded search query text, as to obtain a target judgment document set; and acquiring a target legal provision of the target judgment document set.

According to an example embodiment, wherein acquiring the target legal provision of the target judgment document set includes: paragraphing and analyzing each target judgment document in the target judgment document set, and acquiring a candidate legal provision of the target judgment document set; filtering the candidate legal provision of the target judgment document set to obtain a filtered candidate legal provision; and taking the filtered candidate legal provision as the target legal provision.

According to an example embodiment, wherein the filtered candidate legal provision includes a plurality of provisions, and after filtering the candidate legal provision of the target judgment document set to obtain the filtered candidate legal provision and before taking the filtered candidate legal provision as the target legal provision, the method further includes: determining a weight value of the each target judgment document according to a pre-set condition; calculating an appearance count of each provision in the each target judgment document; sequencing the plurality of provisions according to the weight value of the each target judgment document and the appearance count of the each provision in each target judgment document to obtain a plurality of sequenced provisions; and determining, according to the plurality of sequenced provisions, a target provision returned to a target address, taking the filtered candidate legal provision as the target legal provision including: taking the target provision as the target legal provision.

According to an example embodiment, wherein before searching according to the expanded search query text, as to obtain the target judgment document set, the method further includes: establishing an inverted index for the candidate judgment document to obtain a first inverted list, searching according to the expanded search query text to obtain the target judgment document set including: inputting the expanded search query text into the first inverted list to perform searching to obtain the target judgment document set.

According to an example embodiment, wherein before searching according to the expanded search query text, as to obtain the target judgment document set, the method further includes: paragraphing and analyzing the candidate judgment document, and determining a search paragraph in the candidate judgment document, wherein the search paragraph is a paragraph for describing case content in the candidate judgment document; and establishing an inverted index for the candidate judgment document and the search paragraph in the candidate judgment document, as to obtain a second inverted list, wherein searching according to the expanded search query text, as to obtain the target judgment document set includes: inputting the expanded search query text into the second inverted list to perform searching to obtain the target judgment document set.

According to an embodiment of the present disclosure, a device for searching for a legal provision is provided, including: a first acquiring element, configured to acquire a search keyword in a search query text; a second acquiring element, configured to acquire a legal term which has a meaning similar to and/or the same as a meaning of the search keyword; an expanding element, configured to expand the search query text according to the legal term which has the meaning similar to and/or the same as the meaning of the search keyword, as to obtain an expanded search query text; a searching element, configured to search according to the expanded search query text, as to obtain a target judgment document set; and a third acquiring element, configured to acquire a target legal provision of the target judgment document set.

According to an example embodiment, wherein the third acquiring element includes: an acquiring component, configured to paragraph and analyze each target judgment document in the target judgment document set, and acquire a candidate legal provision of the target judgment document set; a filtering component, configured to filter the candidate legal provision of the target judgment document set, as to obtain a filtered candidate legal provision; and a determining component, configured to take the filtered candidate legal provision as the target legal provision.

According to an example embodiment, wherein the filtered candidate legal provision includes a plurality of provisions, and the device further includes: a first determining element, configured to determine a weight value of each target judgment document according to a pre-set condition; a calculating element, configured to calculate an appearance count of each provision in each target judgment document; a sequencing element, configured to sequence the plurality of provisions according to the weight value of the each target judgment document and the appearance count of the each provision in each target judgment document to obtain a plurality of sequenced provisions; and a second determining element, configured to determine, according to the plurality of sorted provisions, a target provision returned to a target address, wherein the determining component is configured to take the target provision as the target legal provision.

According to an example embodiment, the device further including: a first setup unit, configured to set up an inverted index for candidate judgment documents to obtain a first inverted list, the searching element being further configured to input the expanded search query text into the first inverted list to perform searching to obtain a target judgment document set.

According to an example embodiment, the device further including: a third determination unit, configured to analyze candidate judgment documents by paragraphs, and determine search paragraphs in the candidate judgment documents, wherein the search paragraphs are paragraphs for describing case contents in the candidate judgment documents; and a second setup unit, configured to set up an inverted index for the candidate judgment documents and the search paragraphs in the candidate judgment documents to obtain a second inverted list, the searching element being further configured to input the expanded search query text into the second inverted list to perform searching to obtain a target judgment document set.

The present disclosure adopts the following steps: acquiring a search keyword in a search query text; acquiring a legal term which has a meaning similar to and/or the same as a meaning of the search keyword; expanding the search query text according to the legal term which has the meaning similar to and/or the same as the meaning of the search keyword, as to obtain an expanded search query text; searching according to the expanded search query text, as to obtain a target judgment document set; and acquiring a target legal provision of the target judgment document set. The problem in the relevant art of difficulty in acquisition of a relevant legal provision according to an input search term is solved. A target judgment document set is acquired by means of a search query text, and then a target legal provision of the target judgment document set is acquired. That is, a relationship between the search query text and a legal provision is established by means of the target judgment document set, thereby the effect of obtaining the legal provision relevant to the input search query text is achieved.

### BRIEF DESCRIPTION OF THE DRAWINGS

The drawings, forming a part of the present disclosure, are used to provide further understanding for the present disclosure. The schematic embodiments and illustrations of the present disclosure are used to explain the present disclosure, and do not form improper limits to the present disclosure. In the drawings:

FIG. 1 is a flowchart of a method for searching for a legal provision according to a first embodiment of the present disclosure;

FIG. 2 is a flowchart of a method for searching for a legal provision according to a second embodiment of the present disclosure;

FIG. 3 is a schematic diagram of a device for searching for a legal provision according to a first embodiment of the present disclosure; and

FIG. 4 is a schematic diagram of a device for searching for a legal provision according to a second embodiment of the present disclosure.

### DETAILED DESCRIPTION OF THE EMBODIMENTS

It is important to note that embodiments in the present disclosure and characteristics in the embodiments may be combined mutually under the condition of no conflicts. The present disclosure will be illustrated below with reference to the drawings and in conjunction with the embodiments in detail.

In order to make those skilled in the art better understand the solutions of the present disclosure, the technical solutions in the embodiments of the present disclosure will be clearly and completely described below in conjunction with the drawings in the embodiments of the present disclosure. Obviously, the described embodiments are only a part of the embodiments of the present disclosure, not all of the embodiments. On the basis of the embodiments of the present disclosure, all other embodiments obtained on the premise of no creative work of those skilled in the art shall fall within the scope of protection of the present disclosure.

It is important to note that the description and claims of the present disclosure and terms “first”, “second” and the like in the drawings are used to distinguish similar objects, and do not need to describe a specific sequence or a precedence order. It will be appreciated that data used in such a way may be exchanged under appropriate conditions, in order that the embodiments of the present disclosure described here can be implemented in a sequence except sequences graphically shown or described here. In addition, terms “include” and “have” and any inflexions thereof are intended to cover non-exclusive inclusions. For example, processes, methods, systems, products or equipment containing a series of steps or units do not need to clearly show those steps or units, and may include other inherent steps or units of these processes, methods, products or equipment, which are not clearly shown instead.

According to an embodiment of the present disclosure, a method for searching for a legal provision is provided.

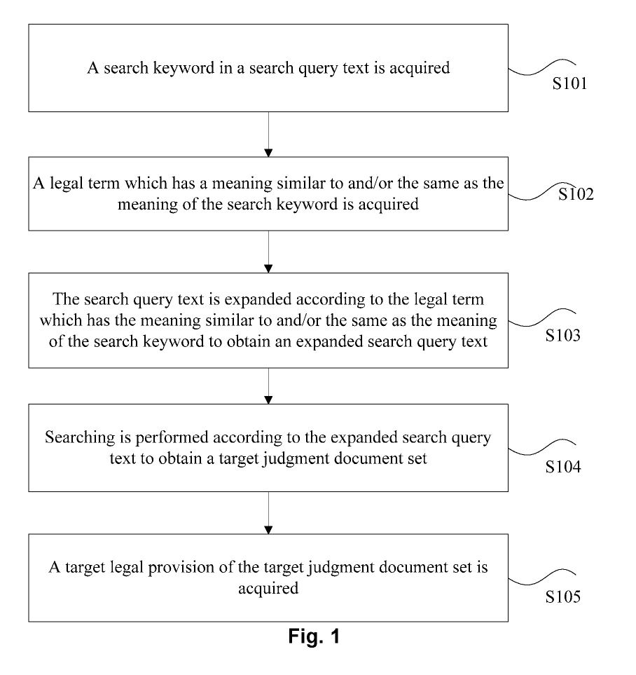

FIG. 1 is a flowchart of a method for searching for a legal provision according to a first embodiment of the present disclosure. As shown in FIG. 1, the method includes the steps as follows.

In step S101, a search keyword in a search query text is acquired.

The search query text in the first embodiment of the present disclosure is a text input based on a dispute case when a party needs to obtain an effective judgment document to serve as a reference for dispute settlement. For example, a search query text input by a party based on a currently settled dispute case is: correlative compensation matters about crash of a drag-racing vehicle against a normal-driving coach. By inputting the search query text, the party desires to acquire the effective judgment document relevant to the input text and a law provision for case judgment of the court to serve as a reference for subsequent settlement.

A search keyword in a search query text is acquired. For example, the search query text is: correlative compensation matters about crash of a drag-racing vehicle against a normal-driving coach. The acquired search keywords in the search query text are: “Drag-racing” and “Compensation”.

In step S102, a legal term which has a meaning similar to and/or the same as the meaning of the search keyword is acquired.

The legal term refers to a word or phrase having a special or specific meaning in the judicial field. For example, “Race driving” is a standard phrase in a legal document, but means “Drag-racing” usually.

For example, the search keywords acquired in step S101 are “Drag-racing” and “Compensation”. The acquired legal term which has a meaning similar to and/or the same as the meaning of “Drag-racing” is “Race driving”, and the acquired legal term which has a meaning similar to and/or the same as the meaning of “Compensation” is “Indemnity”.

In step S103, the search query text is expanded according to the legal term which has the meaning similar to and/or the same as the meaning of the search keyword to obtain an expanded search query text.

The search query text is expanded according to the legal term which has the meaning similar to and/or the same as the meaning of the search keyword. For example, the search query text “Correlative compensation matters about crash of a drag-racing vehicle against a normal-driving coach” is expanded according to “Race driving” which has the meaning similar to and/or the same as the meaning of “Drag-racing” and “Indemnity” which has a meaning similar to and/or the same as the meaning of “Compensation” to obtain an expanded search query text “correlative compensation matters about crash of a drag-racing vehicle against a normal-driving coach”, “Race driving” and “Indemnity”.

In step S104, searching is performed according to the expanded search query text to obtain a target judgment document set.

The target judgment document set includes all target judgment document sets matched with the expanded query text, may contain more than one target judgment document set, or may be null.

By means of the above-mentioned steps, after the search query text is expanded according to the legal term which has the meaning similar to and/or the same as the meaning of the search keyword, a judgment document is searched within a larger range, so as to obtain a richer search result namely to return more target judgment document sets. When the input search keyword is not a legal term, the input search keyword may be remedied by expansion, and therefore a target judgment document set meeting requirements is found, thereby improving the recall rate of a target judgment document set.

Alternatively, before searching according to the expanded search query text to obtain a target judgment document set, the method for searching for the legal provision provided in the first embodiment of the present disclosure further includes: setting up an inverted index for a candidate judgment document to obtain a first inverted list, wherein searching according to the expanded search query text to obtain the target judgment document set includes: inputting the expanded search query text into the first inverted list to perform searching to obtain a target judgment document set.

The inverted index refers to: searching for a record according to an attribute value during practical application. The principle of the inverted index is as follows.

A tokenizer is adopted to perform word segmentation on each document in an input source database, and a keyword extracted from each document is linked with the document; and after a keyword to be searched is input, all documents containing the input keyword is able to be listed reversely, thereby eliminating the process of sequentially searching for the keyword in each document, namely by setting up the inverted index list, achieving the aim of searching for a data source via part of attributes.

A specific implementation manner of the inverted index may be a full-text search engine frame (Lucene) relatively mature in the industry, or may be an enterprise search application server (Solr) or a full-text search engine (Elasticsearch) developed based on the Lucene. In addition, a set of search engines meeting requirements may be developed. The type of an adopted inverted index manner may be determined according to a specific problem in a practical situation, and the implementation manner thereof is not limited in the first embodiment of the present disclosure.

In this step, an inverted index is set up for a full text of each candidate judgment document, after a search query text is input, a tokenizer which is the same as that in a search engine adopted by the inverted index is used to perform word segmentation on the search query text to obtain one or more keywords after word segmentation, and an inverted list is queried and a corresponding target judgment document set is returned.

Alternatively, before searching according to the expanded search query text to obtain the target judgment document set, the method for searching for the legal provision provided in the first embodiment of the present disclosure further includes: the candidate judgment document is analyzed by paragraphs, and a search paragraph in the candidate judgment document is determined, wherein the search paragraph is a paragraph for describing case content in the candidate judgment document; and an inverted index is set up for the candidate judgment document and the search paragraph in the candidate judgment document to obtain a second inverted list, wherein searching according to the expanded search query text to obtain the target judgment document set includes: the expanded search query text is input into the second inverted list to perform searching to obtain a target judgment document set.

Generally speaking, a judgment document has a certain format. That is, it is necessary to describe various elements relevant to a case in a specific paragraph. For example, in the beginning of the judgment document, it is necessary to write information about a plaintiff and information about a client thereof, information about a defendant and information about a client thereof, and the like. Therefore, by capturing specific information in the candidate judgment document, the candidate judgment document may be divided into paragraphs. For another example, in a plaintiff allegation paragraph, subjective facts stated by the plaintiff suing the defendant are mainly recorded; and in addition, in a find-by-try paragraph, the fact finally found by the court in conjunction with proofs of both the plaintiff and the defendant after combining statements of the plaintiff and the defendant. A case description paragraph in the judgment document such as the plaintiff allegation paragraph and the find-by-try paragraph (search paragraph) may serve as an inverted index target judgment document set of case content keywords.

Compared with word segmentation on the full text of a candidate judgment document, an inverted index for each case description paragraph of each candidate judgment document is setup, which can reduce the storage space of an inverted list, and also alleviate redundant indexes brought by keywords contained in paragraphs relevant to non-case description.

In step S105, a target legal provision of the target judgment document set is acquired.

In a judgment document divided into paragraphs, one of the paragraphs describes a legal basis for case judgment of the court, and is usually referred to as a legal provision paragraph. The legal provision paragraph contains information about which legal provisions are specifically used by the court as a judgment basis. For example, an abstract of a legal provision paragraph in a judgment document is as follows:

“In conclusion, on the basis of provisions of Articles 2 and 50 in ‘Labor Law of the People's Republic of China’ as well as Article 31 in ‘Labor Contract Law of the People's Republic of China’, the judgment is as follows.”

From the abstract of the legal provision paragraph in the judgment document, it can be seen that a judgment basis of the court for the case includes three legal provisions namely Articles 2 and 50 in ‘Labor Law of the People's Republic of China’ as well as Article 31 in ‘Labor Contract Law of the People's Republic of China’, and a judgment result is provided for the case finally. Usually, legal provision information carries “Article *”, wherein “*” is a figure.

In a judgment document divided into paragraphs, it is necessary to extract information from a legal provision paragraph of the judgment document to obtain a legal provision. There are many information extraction manners such as a search manner including searching via a regular expression or a rule matching method based on a finite-state machine. The essence is that when the judgment document satisfies a certain pre-set condition such as a pre-set condition “Article *” in the present embodiment, a system will return corresponding information according to a pre-set rule in the present embodiment: such as a pre-set rule of combining “Article *” and all contents in quotation marks (‘ ’) closest to “Article *” in the above into a format of ‘“’Article *” to serve as search return information. The type of an adopted information extraction manner may be determined according to a specific problem in a practical situation, and the implementation manner thereof is not limited in the first embodiment of the present disclosure.

All judgment documents are linked with all legal provisions obtained by information extraction from each judgment document. After paragraph division, information extraction and link setup on the judgment documents, when a judgment document is specified, a legal provision serving as a judgment basis of the court in the judgment document can be obtained.

The method for searching for the legal provision provided in the first embodiment of the present disclosure includes: a search keyword in a search query text is inquired; a legal term which has a meaning similar to and/or the same as the meaning of the search keyword is acquired; the search query text is expanded according to the legal term which has the meaning similar to and/or the same as the meaning of the search keyword to obtain an expanded search query text; searching is performed according to the expanded search query text to obtain a target judgment document set; and a target legal provision of the target judgment document set is acquired. The problem in the relevant art of difficulty in acquisition of a relevant legal provision according to an input search term is solved. A target judgment document set is acquired by means of the search query text, and then the target legal provision of the target judgment document set is acquired. That is, a link between the search query text and the legal provision is set up by means of the target judgment document set, thereby obtaining the legal provision relevant to the input search query text.

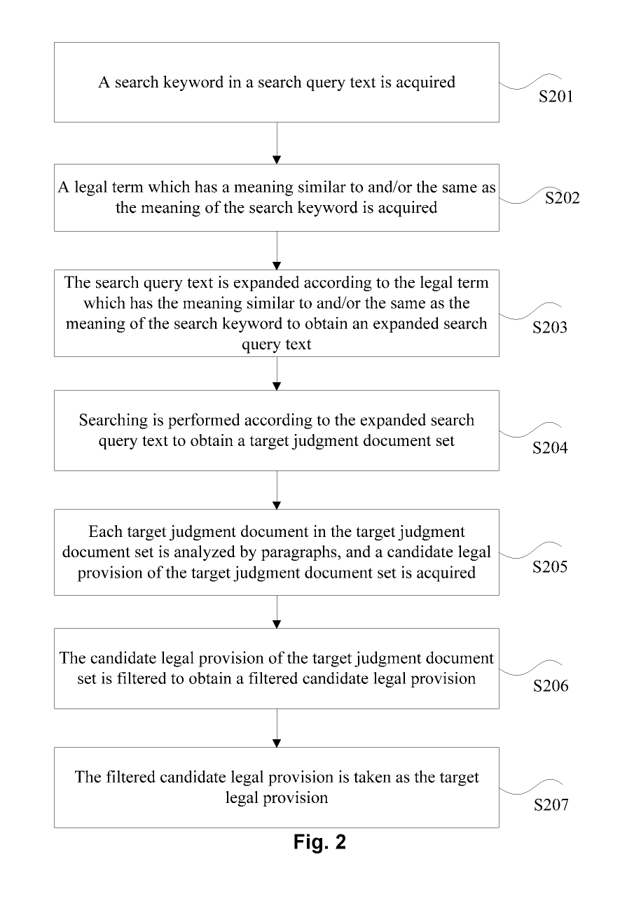

FIG. 2 is a flowchart of a method for searching for a legal provision according to a second embodiment of the present disclosure. FIG. 2 may serve as a preferred implementation manner of the embodiment as shown in FIG. 1. As shown in FIG. 2, the method includes the steps as follows.

In step S201, a search keyword in a search query text is acquired. This step is the same as step S101 in the first embodiment of the present disclosure, and will not be elaborated herein.

In step S202, a legal term which has a meaning similar to and/or the same as the meaning of the search keyword is acquired.

This step is the same as step S102 in the first embodiment of the present disclosure, and will not be elaborated herein.

In step S203, the search query text is expanded according to the legal term which has the meaning similar to and/or the same as the meaning of the search keyword to obtain an expanded search query text.

This step is the same as step S103 in the first embodiment of the present disclosure, and will not be elaborated herein.

In step S204, searching is performed according to the expanded search query text to obtain a target judgment document set.

This step is the same as step S104 in the first embodiment of the present disclosure, and will not be elaborated herein.

In step S205, each target judgment document in the target judgment document set is analyzed by paragraphs, and a candidate legal provision of the target judgment document set is acquired.

Firstly, after the target judgment document set is obtained, the target judgment document set is divided into paragraphs according to the structure of a judgment document. Then, a legal provision paragraph is determined in the target judgment document set divided into paragraphs. Finally, information extraction is performed on the legal provision paragraph of the target judgment document set to obtain a legal provision of the target judgment document set, which serves as a candidate legal provision in the second embodiment of the present disclosure. Like the information extraction method of step S105 in the first embodiment of the present disclosure, an implementation manner of the information extraction method is not limited in the second embodiment of the present disclosure.

In step S206, the candidate legal provision of the target judgment document set is filtered to obtain a filtered candidate legal provision.

Herein, the target judgment document set includes multiple target judgment documents, all the target judgment documents are subjected to information extraction to obtain candidate legal provisions, and therefore repeated legal provisions are very possibly present in the candidate legal provision. For example, a case description text (search query text) is input to obtain two relevant target judgment documents, wherein one of the target judgment documents makes a final judgment on the basis of Articles 2 and 50 in ‘Labor Law of the People's Republic of China’ and Article 31 in ‘Labor Contract Law of the People's Republic of China’, and the other target judgment document makes a final judgment on the basis of Article 2 in ‘Labor Law of the People's Republic of China’ and Article 39 in ‘Labor Law of the People's Republic of China’, so after information extraction on the target judgment document, two pieces of identical information about “Article 2 in ‘Labor Law of the People's Republic of China”’ will be displayed. Therefore, it is necessary to filter the two pieces of identical legal provision information to retain only one piece of information “Article 2 in ‘Labor Law of the People's Republic of China’”, that is, information redundancy caused by the same legal provisions can be eliminated.

In step S207, the filtered candidate legal provision is taken as a target legal provision.

When a party desires to query legal provisions adopted for similar dispute cases, after inputting a case description (search query text), input information is expanded to obtain all target judgment documents. All candidate legal provisions extracted from all the target judgment documents are filtered, each candidate legal provision appears once in the filtered candidate legal provisions, and therefore the filtered candidate legal provision may be taken as a target legal provision for reference of the party.

Alternatively, the filtered candidate legal provision includes multiple provisions, and after filtering the candidate legal provisions of the target judgment document set to obtain a filtered candidate legal provision and before taking the filtered candidate legal provision as a target legal provision, the method for searching for the legal provision provided in the second embodiment of the present disclosure further includes: a weight value of each target judgment document is determined according to a pre-set condition; an appearance count of each provision in each target judgment document is calculated; the multiple provisions are sequenced according to the weight value of each target judgment document and the appearance count of each provision in each target judgment document to obtain multiple sequenced provisions; and a target provision returned to a target address is determined according to the multiple sequenced provisions, wherein taking the filtered candidate legal provision as the target legal provision includes: taking the target provision as the target legal provision.

Before the filtered candidate legal provision is taken as the target legal provision, the filtered candidate legal provisions may be sequenced, and relevancy of the candidate legal provisions to a case input by the party is determined according to a certain pre-set condition. The pre-set condition is a pre-set impact condition, and the impact condition is pre-defined in a non-unique manner. When a judgment document similar to this case is searched by means of a case description, it is inevitable that the relevancy of the found judgment documents to the case description may be different. It can be thus seen that associations between candidate legal provisions corresponding to different target judgment documents and the case description input by the party are different. Therefore, it is necessary to endow different target judgment documents with different weights, such that the sequence of the target judgment documents is relevant to the associations with the case description. For example, an implementation manner may be as follows.

When the input case description matches m judgment documents and the m judgment documents are endowed with respective weight values according to a pre-set condition respectively, the respective weight values may be expressed as w₁, w₂, . . . , wₘ, the weight value corresponding to each judgment document represents similarity of the judgment document to the input case description. n candidate legal provisions are obtained by analyzing the m judgment documents by paragraphs and filtering the m judgment documents, and application of the i^{th} legal provision in the j^{th} judgment document satisfies yᵢⱼ,

$${y}_{ij} = \{ \begin{matrix}1 & i ∈ j \\ 0 & other\end{matrix} ,$$

That is, the i^{th} legal provision may or may not be applied in the j^{th} judgment document. So, the RankScore, of the i^{th} legal provision under a specific case description may be expressed as:

RankScoreᵢ=Σⱼ₌₁^{m}wⱼ*yᵢⱼ,

That is, the RankScore, of the i^{th} legal provision is the sum of weight values of all judgment documents applying the legal provision. Finally, the RankScores of all legal provisions are sequenced in a descending order, the legal provisions are returned according to the current sequency, or the top-ranking legal provisions are returned. The quantity of legal provisions may be pre-defined in a pre-set condition.

The method for searching for the legal provision provided in the second embodiment of the present disclosure includes: a search keyword in a search query text is acquired; a legal term which has a meaning similar to and/or the same as the meaning of the search keyword is acquired; the search query text is expanded according to the legal term which has the meaning similar to and/or the same as the meaning of the search keyword to obtain an expanded search query text; searching is performed according to the expanded search query text to obtain a target judgment document set; each target judgment document in the target judgment document set is analyzed by paragraphs, and a candidate legal provision of the target judgment document set is acquired; the candidate legal provision of the target judgment document set is filtered to obtain a filtered candidate legal provision; and the filtered candidate legal provision is taken as a target legal provision. The problem in the relevant art of difficulty in acquisition of a relevant legal provision according to an input search term is solved, thereby obtaining the legal provision relevant to the input search query text. A filtered legal provision is obtained by filtering the candidate legal provision extracted from the target judgment document set, and the filtered candidate legal provision is taken as a target legal provision, thereby eliminating information redundancy caused by the same legal provisions.

It is important to note that the steps shown in the flowchart of the drawings may be executed in a computer system including, for example, a set of computer-executable instructions. Moreover, although a logic sequence is shown in the flowchart, the shown or described steps may be executed in a sequence different from the sequence here under certain conditions.

The embodiments of the present disclosure also provide a device for searching for a legal provision. It is important to note that the device for searching for the legal provision in the embodiment of the present disclosure may be used to execute the method for searching for the legal provision provided in the embodiment of the present disclosure. The device for searching for the legal provision provided in the embodiment of the present disclosure will be introduced below.

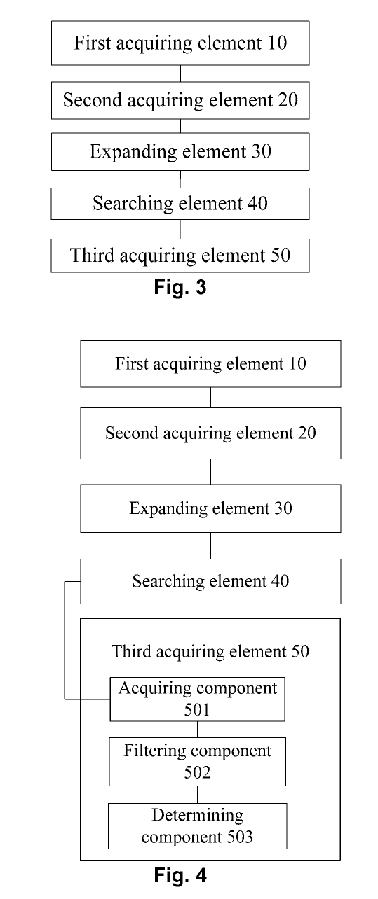

FIG. 3 is a schematic diagram of a device for searching for a legal provision according to a first embodiment of the present disclosure. As shown in FIG. 3, the device includes: a first acquiring element 10, a second acquiring element 20, an expanding element 30, a searching element 40 and a third acquiring element 50.

The first acquiring element 10 is configured to acquire a search keyword in a search query text.

The second acquiring element 20 is configured to acquire a legal term which has a meaning similar to and/or the same as a meaning of the search keyword.

The expanding element 30 is configured to expand the search query text according to the legal term which has the meaning similar to and/or the same as the meaning of the search keyword to obtain an expanded search query text.

The searching element 40 is configured to search according to the expanded search query text to obtain a target judgment document set.

The third acquiring element 50 is configured to acquire a target legal provision of the target judgment document set.

Here, it is important to note that the first acquiring element 10, the second acquiring element 20, the expanding element 30, the searching element 40 and the third acquiring element 50 may be operated in a computer terminal by serving as a part of the device, functions implemented by the above-mentioned modules may be executed by means of a processor in the computer terminal, and the computer terminal may be terminal equipment such as a smart phone (Android phone, iOS phone or the like), a tablet computer, a palmtop, Mobile Internet Devices (MID), PAD.

According to the device for searching for the legal provision provided in the first embodiment of the present disclosure, a first acquiring element 10 acquires a search keyword in a search query text; a second acquiring element 20 acquires a legal term which has the meaning similar to and/or the same as the meaning of the search keyword; an expanding element 30 expands the search query text according to the legal term which has the meaning similar to and/or the same as the meaning of the search keyword to obtain an expanded search query text; a searching element 40 performs searching according to the expanded search query text to obtain a target judgment document set; and a third acquiring element 50 acquires a target legal provision of the target judgment document set. The problem in the relevant art of difficulty in acquisition of a relevant legal provision according to an input search term is solved. The third acquiring element 50 acquires the target legal provision of the target judgment document set, thereby obtaining the legal provision relevant to the input search query text.

Alternatively, the device for searching for the legal provision provided in the first embodiment of the present disclosure further includes: a first setup element, configured to set up an inverted index for a candidate judgment document to obtain a first inverted list, and the searching element is further configured to input the expanded search query text into the first inverted list to perform searching to obtain a target judgment document set.

Alternatively, the device for searching for the legal provision provided in the first embodiment of the present disclosure further includes: a third determining element, configured to analyze the candidate judgment document by paragraphs, and determine a search paragraph in the candidate judgment document, wherein the search paragraph is a paragraph for describing case content in the candidate judgment document; and a second setup element, configured to set up an inverted index for the candidate judgment document and the search paragraph in the candidate judgment document to obtain a second inverted list, wherein the searching element is further configured to input the expanded search query text into the second inverted list to perform searching to obtain a target judgment document set.

FIG. 4 is a schematic diagram of a device for searching for a legal provision according to a second embodiment of the present disclosure. FIG. 4 may serve as a preferred implementation manner of the embodiment as shown in FIG. 3. As shown in FIG. 4, the device includes: a first acquiring element 10, a second acquiring element 20, an expanding element 30, a searching element 40 and a third acquiring element 50, wherein the third acquiring element 50 includes an acquiring component 501, a filtering component 502 and a determining component 503.

The first acquiring element 10 is configured to acquire a search keyword in a search query text.

The second acquiring element 20 is configured to acquire a legal term which has a meaning similar to and/or the same as the meaning of the search keyword.

The expanding element 30 is configured to expand the search query text according to the legal term which has the meaning similar to and/or the same as the meaning of the search keyword to obtain an expanded search query text.

The searching element 40 is configured to search according to the expanded search query text to obtain a target judgment document set.

The third acquiring element 50 includes: the acquiring component 501, configured to analyze each target judgment document in the target judgment document set by paragraphs, and acquire a candidate legal provision of the target judgment document set; the filtering component 502, configured to filter the candidate legal provision of the target judgment document set to obtain a filtered candidate legal provision; and the determining component 503, configured to take the filtered candidate legal provision as the target legal provision.

Here, it is important to note that the first acquiring element 10, the second acquiring element 20, the expanding element 30, the searching element 40 and the third acquiring element 50 including the acquiring component 501, the filtering component 502 and the determining component 503 may be operated in a computer terminal by serving as a part of the device, functions implemented by the above-mentioned modules may be executed by means of a processor in the computer terminal, and the computer terminal may be terminal equipment such as a smart phone (Android phone, iOS phone or the like), a tablet computer, a palmtop, MID, PAD.

According to the device for searching for the legal provision provided in the second embodiment of the present disclosure, a first acquiring element 10 acquires a search keyword in a search query text; a second acquiring element 20 acquires a legal term which has a meaning similar to and/or the same as the meaning of the search keyword; an expanding element 30 expands the search query text according to the legal term which has the meaning similar to and/or the same as the meaning of the search keyword to obtain an expanded search query text; a searching element 40 performs searching according to the expanded search query text to obtain a target judgment document set; an acquiring component 501 analyzes each target judgment document in the target judgment document set by paragraphs, and acquires a candidate legal provision of the target judgment document set; a filtering component 502 filters the candidate legal provision of the target judgment document set to obtain a filtered candidate legal provision; and a determining component 503 takes the filtered candidate legal provision as a target legal provision. The problem in the relevant art of difficulty in acquisition of a relevant legal provision according to an input search term is solved, thereby obtaining the legal provision relevant to the input search query text. The acquiring component 501 analyzes each target judgment document in the target judgment document set by paragraphs, and acquires a candidate legal provision of the target judgment document set, the filtering component 502 filters the candidate legal provision of the target judgment document set to obtain a filtered candidate legal provision, and the determining component 503 takes the filtered candidate legal provision as the target legal provision, thereby eliminating information redundancy caused by the same legal provisions.

Alternatively, the filtered candidate legal provision includes multiple provisions, and the device for searching for the legal provision provided in the second embodiment of the present disclosure further includes: a first determining element, configured to determine a weight value of each target judgment document according to a pre-set condition; a calculating element, configured to calculate an appearance count of each provision in each target judgment document; a sequencing element, configured to sequence the multiple provisions according to the weight value of each target judgment document and the appearance count of each provision in each target judgment document to obtain multiple sequenced provisions; and a second determining element, configured to determine a target provision returned to a target address according to the multiple sequenced provisions, the determining component being configured to take the target provision as the target legal provision.

Each function element provided in the embodiments of the present disclosure may be operated in a mobile terminal, a computer terminal or a similar operating device, or may be stored as a part of a storage medium.

Hereupon, the embodiments of the present disclosure may provide a computer terminal, and the computer terminal may be any one computer terminal equipment in a computer terminal group. Alternatively, in the present embodiment, the computer terminal may also be replaced with terminal equipment such as a mobile terminal.

Alternatively, in the present embodiment, the computer terminal may be located on at least one piece of network equipment in multiple pieces of network equipment of a computer network.

In the present embodiment, the computer terminal may execute program codes of the following steps in the method for searching for the legal provision: acquiring a search keyword in a search query text; acquiring a legal term which has a meaning similar to and/or the same as the meaning of the search keyword; expanding the search query text according to the legal term which has a meaning similar to and/or the same as the meaning of the search keyword to obtain an expanded search query text; searching according to the expanded search query text to obtain a target judgment document set; and acquiring a target legal provision of the target judgment document set.

Alternatively, the computer terminal may include: one or more processors, memories and transmission devices.

Herein, the memory may be configured to store a software program and a module such as a program instruction/module corresponding to the method for searching for the legal provision and device in the embodiments of the present disclosure, and the processor executes various function applications and data processing by operating the software program and the module stored in the memory, namely implementing the above-mentioned method for searching for the legal provision. The memory may include a high-speed random access memory, and may further include a nonvolatile memory such as one or more magnetic storage devices, flash memories or other nonvolatile solid state memories. In some examples, the memory may further include memories remote from the processor, wherein these remote memories may be connected to a terminal via a network. The network examples include, but not limited to, internet, intranet, a local area network, a mobile communication network and combinations.

The transmission device is used to receive or transmit data via a network. The specific network examples may include a cable network and a radio network. In an example, the transmission device includes a Network Interface Controller (NIC), which may be connected with other network equipment and routers via a network cable so as to communicate with the internet or local area network. In an example, the transmission device is a Radio Frequency (RF) module, used to communicate with the internet in a radio manner.

Herein, specifically, the memory is used to store information about a pre-set action condition and a pre-set right user, and an application program.

The processor may call the information and the application program stored by the memory via the transmission device, so as to execute program codes of the method steps in each alternative or preferred embodiment in the above-mentioned method embodiments.

Those of ordinary skill in the art may understand that the computer terminal may be terminal equipment such as a smart phone (Android phone, iOS phone or the like), a tablet computer, a palmtop, MID, PAD.

Those of ordinary skill in the art may understand that all or some steps in various methods of the above-mentioned embodiments may be completed by instructing relevant hardware of terminal equipment via a program, the program may be stored in a computer-readable storage medium, and the storage medium may include: a flash disk, a Read-Only Memory (ROM), a Random Access Memory (RAM), a magnetic disk or an optical disk.

The embodiments of the present disclosure also provide a storage medium. Alternatively, in the present embodiment, the storage medium may be used to store program codes for executing the method for searching for the legal provision provided in the above-mentioned method embodiments and device embodiments.

Alternatively, in the present embodiment, the storage medium may be located in any one computer terminal in a computer terminal group in a computer network, or in any one mobile terminal in a mobile terminal group.

Alternatively, in the present embodiment, the storage medium is configured to store program codes for executing the following steps: acquiring a search keyword in a search query text; acquiring a legal term which has a meaning similar to and/or the same as the meaning of the search keyword; expanding the search query text according to the legal term which has the meaning similar to and/or the same as the meaning of the search keyword to obtain an expanded search query text; searching according to the expanded search query text to obtain a target judgment document set; and acquiring a target legal provision of the target judgment document set.

Alternatively, in the present embodiment, the storage medium may also be configured to store program codes of various preferred or alternative method steps provided by the method for searching for the legal provision.

The method and device for searching for the legal provision according to the present disclosure are described as above in an example manner with reference to the drawings. However, those skilled in the art should understand that various improvements may also be made on the method and device for searching for the legal provision provided in the present disclosure without departing from the content of the present disclosure. Therefore, the scope of protection of the present disclosure should be determined by the content of the appended claims.

The device for searching for the legal provision includes a processor and a memory. The first acquiring element, the second acquiring element, the expanding element, the searching element and the third acquiring element are stored in the memory as program units, and the processor executes the program units stored in the memory to achieve corresponding functions.

The processor contains a kernel, which calls a corresponding program unit from the memory. There may be one or more kernels, and a legal provision is searched by adjusting kernel parameters.

The memory may include a volatile memory, an RAM and/or a non-volatile memory in a computer-readable medium such as an ROM or flash RAM, the memory including at least one storage chip.

The present disclosure also provides a computer program product. When being executed on data processing equipment, the computer program product is suitable for executing program codes initializing the following method steps: acquiring a search keyword in a search query text; acquiring a legal term which has a meaning similar to and/or the same as the meaning of the search keyword; expanding the search query text according to the legal term which has the meaning similar to and/or the same as the meaning of the search keyword to obtain an expanded search query text; searching according to the expanded search query text to obtain a target judgment document set; and acquiring a target legal provision of the target judgment document set.

It is important to note that for simple description, each of the above-mentioned method embodiments is expressed as a series of action combinations. However, those skilled in the art should know that the embodiments of the present disclosure are not limited by a described action sequence. That is because some steps may be executed in other sequences or at the same time according to the embodiments of the present disclosure. Secondly, those skilled in the art should also know that the embodiments described in the description fall within alternative embodiments, and involved actions and modules may not be necessary for the present disclosure.

In the above-mentioned embodiments, descriptions for each embodiment are emphasized respectively, and parts which are not elaborated in a certain embodiment may refer to relevant descriptions for other embodiments.

In several embodiments provided by the present disclosure, it will be appreciated that the disclosed device may be implemented in another manner. For example, the device embodiment described above is only schematic. For example, division of the units is only logic function division, and other division manners may be adopted during practical implementation. For example, multiple units or components may be combined or integrated into another system, or some characteristics may be neglected or not executed.

The above-mentioned units described as separate parts may or may not be physically separated, and parts displayed as units may or may not be physical units, and namely may be located in the same place, or may also be distributed to multiple network units. Part or all of the units may be selected to achieve the purpose of the solutions of the present embodiment according to a practical requirement.

In addition, each function unit in each embodiment of the present disclosure may be integrated into a processing unit, each unit may also exist independently, and two or more than two units may also be integrated into a unit. The above-mentioned integrated unit may be implemented in a form of hardware, and may also be implemented in a form of software function unit.

Obviously, those skilled in the art shall understand that all of the above-mentioned modules or steps in the present disclosure may be implemented by using a general calculation device, may be centralized on a single calculation device or may be distributed on a network composed of multiple calculation devices. Alternatively, they may be implemented by using executable program codes of the calculation devices. Thus, they may be stored in a storage device and executed by the calculation devices, or they are manufactured into each integrated circuit module respectively, or multiple modules or steps therein are manufactured into a single integrated circuit module. Thus, the present disclosure is not limited to combination of any specific hardware and software.

The above is only the preferred embodiments of the present disclosure, and not used to limit the present disclosure. As will occur to those skilled in the art, the present disclosure is susceptible to various modifications and changes. Any modifications, equivalent replacements, improvements and the like made within the spirit and principle of the present disclosure should fall within the scope of protection of the present disclosure.

1. A method for searching for a legal provision, comprising:
acquiring a search keyword in a search query text;
acquiring a legal term which has a meaning similar to and/or the same as a meaning of the search keyword;
expanding the search query text according to the legal term, which has the meaning similar to and/or the same as the meaning of the search keyword, to obtain an expanded search query text;
searching according to the expanded search query text to obtain a target judgment document set; and
acquiring a target legal provision of the target judgment document set.

2. The method as claimed in claim 1, wherein acquiring the target legal provision of the target judgment document set comprises:
paragraphing and analyzing each target judgment document in the target judgment document set, and acquiring a candidate legal provision of the target judgment document set;
filtering the candidate legal provision of the target judgment document set to obtain a filtered candidate legal provision; and
taking the filtered candidate legal provision as the target legal provision.

3. The method as claimed in claim 2, wherein the filtered candidate legal provision comprises a plurality of provisions, and after filtering the candidate legal provision of the target judgment document set to obtain the filtered candidate legal provision and before taking the filtered candidate legal provision as the target legal provision, the method further comprises:
determining a weight value of the each target judgment document according to a pre-set condition;
calculating an appearance count of each provision in the each target judgment document;
sequencing the plurality of provisions according to the weight value of the each target judgment document and the appearance count of the each provision in each target judgment document to obtain a plurality of sequenced provisions; and
determining, according to the plurality of sequenced provisions, a target provision returned to a target address, wherein taking the filtered candidate legal provision as the target legal provision comprises taking the target provision as the target legal provision.

4. The method as claimed in claim 1, wherein before searching according to the expanded search query text to obtain the target judgment document set, the method further comprises:
establishing an inverted index for a candidate judgment document to obtain a first inverted list,
wherein searching according to the expanded search query text to obtain the target judgment document set comprises inputting the expanded search query text into the first inverted list to perform searching to obtain the target judgment document set.

5. The method as claimed in claim 1, wherein before searching according to the expanded search query text to obtain the target judgment document set, the method further comprises:
paragraphing and analyzing a candidate judgment document, and determining a search paragraph in the candidate judgment document, wherein the search paragraph is a paragraph for describing case content in the candidate judgment document; and
establishing an inverted index for the candidate judgment document and the search paragraph in the candidate judgment document to obtain a second inverted list,
wherein searching according to the expanded search query text to obtain the target judgment document set comprises:
inputting the expanded search query text into the second inverted list to perform searching to obtain the target judgment document set.

6. A device for searching for a legal provision, comprising:
a first acquiring element configured to acquire a search keyword in a search query text;
a second acquiring element configured to acquire a legal term which has a meaning similar to and/or the same as a meaning of the search keyword;
an expanding element configured to expand the search query text according to the legal term which has the meaning similar to and/or the same as the meaning of the search keyword, as to obtain an expanded search query text;
a searching element configured to search according to the expanded search query text, as to obtain a target judgment document set; and
a third acquiring element configured to acquire a target legal provision of the target judgment document set.

7. The device as claimed in claim 6, wherein the third acquiring element comprises:
an acquiring component configured to paragraph and analyze each target judgment document in the target judgment document set, and acquire a candidate legal provision of the target judgment document set;
a filtering component configured to filter the candidate legal provision of the target judgment document set, as to obtain a filtered candidate legal provision; and
a determining component configured to take the filtered candidate legal provision as the target legal provision.

8. The device as claimed in claim 7, wherein the filtered candidate legal provision comprises a plurality of provisions, and the device further comprises:
a first determining element configured to determine a weight value of each target judgment document according to a pre-set condition;
a calculating element configured to calculate an appearance count of each provision in each target judgment document;
a sequencing element configured to sequence the plurality of provisions according to the weight value of the each target judgment document and the appearance count of the each provision in each target judgment document to obtain a plurality of sequenced provisions; and
a second determining element configured to determine, according to the plurality of sorted provisions, a target provision returned to a target address,
wherein the determining component is configured to take the target provision as the target legal provision.

9. The device as claimed in claim 6, further comprising:
a first setup unit configured to set up an inverted index for candidate judgment documents to obtain a first inverted list,
the searching element being further configured to input the expanded search query text into the first inverted list to perform searching to obtain a target judgment document set.

10. The device as claimed in claim 6, further comprising:
a third determination unit configured to analyze candidate judgment documents by paragraphs, and determine search paragraphs in the candidate judgment documents, wherein the search paragraphs are paragraphs for describing case contents in the candidate judgment documents; and
a second setup unit configured to set up an inverted index for the candidate judgment documents and the search paragraphs in the candidate judgment documents to obtain a second inverted list,
the searching element being further configured to input the expanded search query text into the second inverted list to perform searching to obtain a target judgment document set.
